(19) United States
(12) Patent Application Publication
(10) Pub. No.: US 2025/0390749 A1
(43) Pub. Date: Dec. 25, 2025

(54) METHOD AND SYSTEM FOR ADAPTING LARGE LANGUAGE MODEL FOR SPECIFIC TASKS

(71) Applicant: L&T TECHNOLOGY SERVICES LIMITED, Chennai (IN)

(72) Inventors: SUDHIR BHADAURIA, Ahmedabad (IN); VIKRAM SUBRAMANI, Krishnagiri (IN)

(21) Appl. No.: 18/940,898

(22) Filed: Nov. 8, 2024

(30) Foreign Application Priority Data
Jun. 20, 2024 (IN) 202441047442

(51) Int. Cl. G06N 3/082; G06N 3/0475

(52) U.S. Cl. CPC G06N 3/082; G06N 3/0475

(57) ABSTRACT

A method and a system of adapting large language model for specific tasks is disclosed. A processor receives a pretrained LLM, training dataset for each of a plurality of adapters, and a set of target layers. A set of layers are extracted from the pretrained LLM based on the set of target layers. The set of layers are initialized as a set of shared layers for each of the plurality of adapters. A plurality of task specific models is created based on the plurality of adapters and the set of shared layers. Each of the plurality of task specific models are trained with a corresponding training dataset, concurrently.

### TECHNICAL FIELD

This disclosure relates generally to large language model and more particularly to a method and system for adapting large language model for specific tasks.

### BACKGROUND

Large Language Models (LLMs) are artificial intelligence algorithm trained on vast amounts of text data to understand and generate human-like text. They are commonly used for various natural language processing (NLP) tasks such as text generation, translation, and summarization. In the field of artificial intelligence, agents (also referred to as adapters) are autonomous entities that can sense their environment, make decisions, and perform actions to achieve specific goals. These agents can work in many different fields, including gaming, robotics, and customer service. To accomplish collective goals or solve complex problems, several agents collaborate. Each agent can have unique goals, knowledge, and decision-making processes which allows them for collaboration or competition to improve outcomes. When every agent has the same LLM, this synergy is very strong since job distribution and contextual adaption allow for specialization to happen. Despite the remarkable capabilities of LLMs, efficiently adapting them to various specialized tasks within a multi-agent system (MAS) presents several challenges, such as computational resource constraints, operational costs, and dynamic adaptation.

Existing solutions involve two primary approaches: task allocation and contextual adaptation. Task allocation involves assigning specific roles or tasks to each agent within the MAS, with each agent fine-tuning the shared LLM on relevant data specific to its task. Contextual adaptation allows the LLM to adjust its knowledge and embeddings based on the context provided by each agent. However, these solutions do not inherently improve the pretrained model's knowledge for specific tasks and rely heavily on the initial pretrained knowledge. For large-scale or real-time applications, repeated fine-tuning for every individual task is impractical due to the rise in training time and operational cost. This results in inefficiencies that hinder the practical deployment and scalability of LLMs in dynamic, multi-agent environments. Additionally, the necessity for continual retraining and adaptation limits the responsiveness of the system to real-time changes and demands.

Therefore, there is a requirement for a methodology to adapt large language model for specific tasks.

### SUMMARY OF THE INVENTION

In an embodiment, a method of adapting large language model (LLM) for specific tasks is disclosed. The method may include receiving, by a processor, a pretrained LLM, training dataset for each of a plurality of adapters, and a set of target layers. In an embodiment, each of the plurality of adapters may be associated with a corresponding task. In an embodiment, the set of target layers may be one or more layers from a plurality of layers of the pretrained LLM where each of the plurality of adapters may be added. The method may further include extracting, by the processor, a set of layers from the pretrained LLM based on the set of target layers. The method may further include initializing, by the processor, the set of layers as a set of shared layers for each of the plurality of adapters. The method may further include creating, by the processor, a plurality of task specific models based on the plurality of adapters and the set of shared layers. In an embodiment, each of the plurality of task specific models may be associated with a corresponding adapter for the corresponding task. The method may further include training, by the processor, each of the plurality of task specific models with a corresponding training dataset, concurrently.

In another embodiment, a system for adapting large language model (LLM) for specific tasks is disclosed. The system may include a processor and a memory communicably coupled to the processor, wherein the memory may store processor-executable instructions, which when executed by the processor may cause the processor to receive a pretrained LLM, training dataset for each of a plurality of adapters, and a set of target layers. In an embodiment, each of the plurality of adapters may be associated with a corresponding task. In an embodiment, the set of target layers may be one or more layers from a plurality of layers of the pretrained LLM where each of the plurality of adapters may be added. The processor may further extract a set of layers from the pretrained LLM based on the set of target layers. The processor may further initialize the set of layers as a set of shared layers for each of the plurality of adapters. The processor may further create a plurality of task specific models based on the plurality of adapters and the set of shared layers. In an embodiment, each of the plurality of task specific models may be associated with a corresponding adapter for the corresponding task. The processor may further train each of the plurality of task specific models, concurrently, with a corresponding training dataset.

It is to be understood that both the foregoing general description and the following detailed description are exemplary and explanatory only and are not restrictive of the invention, as claimed.

### BRIEF DESCRIPTION OF THE DRAWING

The accompanying drawings, which are incorporated in and constitute a part of this disclosure, illustrate exemplary embodiments and, together with the description, serve to explain the disclosed principles.

FIG. 1 is a block diagram of an exemplary system for adapting large language model (LLM) for specific tasks, in accordance with an embodiment of the present disclosure.

FIG. 2 is a schematic diagram of a computing device of the exemplary system of FIG. 1, in accordance with an embodiment of the present disclosure.

FIG. 3 illustrates an exemplary pretrained LLM, in accordance with an embodiment of the present disclosure.

FIG. 4 is a flow diagram of a methodology of adapting LLM for specific tasks, in accordance with an embodiment of present disclosure.

FIG. 5 is a flow diagram of a methodology of training each of plurality of task specific models, in accordance with an embodiment of present disclosure.

### DETAILED DESCRIPTION OF THE DRAWINGS

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the scope of the disclosed embodiments. It is intended that the following detailed description be considered exemplary only, with the true scope being indicated by the following claims. Additional illustrative embodiments are listed.

Further, the phrases “in some embodiments”, “in accordance with some embodiments”, “in the embodiments shown”, “in other embodiments”, and the like mean a particular feature, structure, or characteristic following the phrase is included in at least one embodiment of the present disclosure and may be included in more than one embodiment. In addition, such phrases do not necessarily refer to the same embodiments or different embodiments. It is intended that the following detailed description be considered exemplary only, with the true scope being indicated by the following claims.

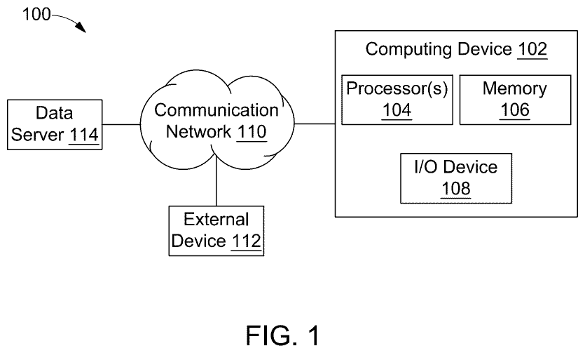

Referring now to FIG. 1, a block diagram of an exemplary system 100 for adapting large language model (LLM) for specific tasks is illustrated, in accordance with an embodiment of the present disclosure. The system 100 may include a computing device 102, an external device 112, and a data server 114 communicably coupled to each other through a wired or wireless communication network 110. The computing device 102 may include a processor 104, a memory 106 and an input/output (I/O) device 108.

In an embodiment, examples of processor(s) 104 may include, but are not limited to, an Intel® Itanium® or Itanium 2 processor(s), or AMD® Opteron® or Athlon MP® processor(s), Motorola® lines of processors, Nvidia®, FortiSOC™, system on a chip processors or other future processors.

In an embodiment, the memory 106 may store instructions that, when executed by the processor 104, and cause the processor 104 to adapt the LLM for specific tasks, as will be discussed in greater detail herein below. In an embodiment, the memory 106 may be a non-volatile memory or a volatile memory. In an embodiment, the memory 106 may also store a single module or a combination of different modules to adapt the LLM for specific tasks. Examples of non-volatile memory may include but are not limited to, a flash memory, a Read Only Memory (ROM), a Programmable ROM (PROM), Erasable PROM (EPROM), and Electrically EPROM (EEPROM) memory. Further, examples of volatile memory may include but are not limited to, Dynamic Random Access Memory (DRAM), and Static Random-Access memory (SRAM).

In an embodiment, the I/O device 108 may comprise of variety of interface(s), for example, interfaces for data input and output devices, and the like. The I/O device 108 may facilitate inputting of instructions by a user communicating with the computing device 102. In an embodiment, the I/O device 108 may be wirelessly connected to the computing device 102 through wireless network interfaces such as Bluetooth®, infrared, or any other wireless radio communication known in the art. In an embodiment, the I/O device 108 may be connected to a communication pathway for one or more components of the computing device 102 to facilitate the transmission of inputted instructions and output results of data generated by various components such as, but not limited to, processor(s) 104 and memory 106.

In an embodiment, the data server 114 may be enabled in a remote cloud server or a co-located server and may include a database to store pretrained LLM, training dataset, and other data necessary for the system 100 such as, but not limited to, historical data, and/or training configuration, trained adapters (also referred to as fine-tuned adapters). In an embodiment, the data server 114 may store data input by an external device 112 (e.g., training configuration, target layers, etc.) or output generated by the computing device 102 (e.g., trained adapters). It is to be noted that within the data server 114, a pretrained LLM is stored for use by the computing device. In an embodiment, examples of the pretrained LLM may include, but are not limited to, zephyr, code LLAMA, GPT, etc. The pretrained LLM stored within the data server 114 serves as a foundational component for various computational tasks and applications. In an embodiment, the computing device 102 may be communicably coupled with the data server 114 through the communication network 110.

In an embodiment, the communication network 110 may be a wired or a wireless network or a combination thereof. The communication network 110 can be implemented as one of the different types of networks, such as but not limited to, ethernet IP network, intranet, local area network (LAN), wide area network (WAN), or a Metropolitan Area Network (MAN). Various devices in the system 100 may be configured to connect to the communication network 110, in accordance with various wired and wireless communication protocols. Examples of such wired and wireless communication protocols may include, but are not limited to, a Transmission Control Protocol and Internet Protocol (TCP/IP), User Datagram Protocol (UDP), Hypertext Transfer Protocol (HTTP), File Transfer Protocol (FTP), Zig Bee, EDGE, IEEE 802.11, light fidelity (Li-Fi), 802.16, IEEE 802.11s, IEEE 802.11g, multi-hop communication, wireless access point (AP), device to device communication, cellular communication protocols, and Bluetooth (BT) communication protocols. Further, the communication network 110 can include a variety of network devices, including routers, bridges, servers, computing devices, storage devices, and the like.

In an embodiment, the computing device 102 may receive a plurality of inputs from the external device 112 through the communication network 110. In an embodiment, the computing device 102 and the external device 112 may be a computing system, including but not limited to, a laptop computer, a desktop computer, a notebook, a workstation, a server, a portable computer, a handheld or a mobile device. In an embodiment, the computing device 102 may be, but not limited to, in-built into the external device 112 or may be a standalone computing device.

In an embodiment, the computing device 102 may perform various processing in order to adapt the LLM for specific tasks. By way of an example, the computing device 102 may receive the pretrained LLM, training dataset for each of a plurality of adapters, and a set of target layers as input. In an embodiment, the pretrained LLM may be a trained LLM for a specific domain. In an embodiment, each of the plurality of adapters may be associated with a corresponding task. In an embodiment, the task may include, but is not limited to, text summarization, question & answering, and text translation related to text data (e.g., financial reports) of a specific domain (e.g., finance). In an embodiment, the plurality of adapters may be created based on the set of target layers and the pretrained LLM using one of a plurality of adapter creation techniques. In an embodiment, the adapter creation techniques may include a Low-Rank Adaptation (LoRA), a Quantized Low-Rank Adaptation (QLoRA), prefix tuning, and so forth.

In an embodiment, the set of target layers may be one or more layers from a plurality of pretrained LLM where each of the plurality of adapters may be added. In an embodiment, the set or target layers may be a default selection of one or more of the plurality of layers of the pretrained LLM. It should be noted that the default selection may be based on model complexity, resource constraints, and hardware capabilities. Alternatively, in an embodiment, the set of target layers may be specified by the user based on model complexity, resource constraints, and hardware capabilities as well as based on their preference and domain experience. Further, for example, in an embodiment, the user may modify the default selection based on their preference and domain experience.

The computing device 102 may further extract a set of layers from the pretrained LLM based on the set of target layers. The computing device 102 may subsequently initialize the set of layers (i.e., the extracted layers) as a set of shared layers for each of the plurality of adapters.

The computing device 102 may further create a plurality of task specific models based on the plurality of adapters and the set of shared layers. In particular, each of the plurality of task specific models may include a corresponding adapter and the set of shared layers.

The computing device 102 may further receive training configuration for each of the plurality of task specific models as an input from the user. In an embodiment, the training configuration may include a learning rate, a batch size, and a number of training epochs.

The computing device 102 may further train each of the plurality of task specific models with a corresponding training dataset, concurrently. In an embodiment, training each of the plurality of task specific models may be based on a corresponding training configuration for the corresponding task specific model. In an embodiment, in order to train each of the plurality of task specific models, the computing device 102 may input the corresponding training dataset to a corresponding task specific model. The computing device 102 may further tune adapter weights of the corresponding adapter while keeping weights of the pretrained LLM frozen (i.e., unchanged). In an embodiment, in order to tune adapter weights, the computing device 102 may determine a loss for the corresponding task specific model. The computing device 102 may further update the adapter weights based on the loss while keeping weights of the set of shared layers frozen.

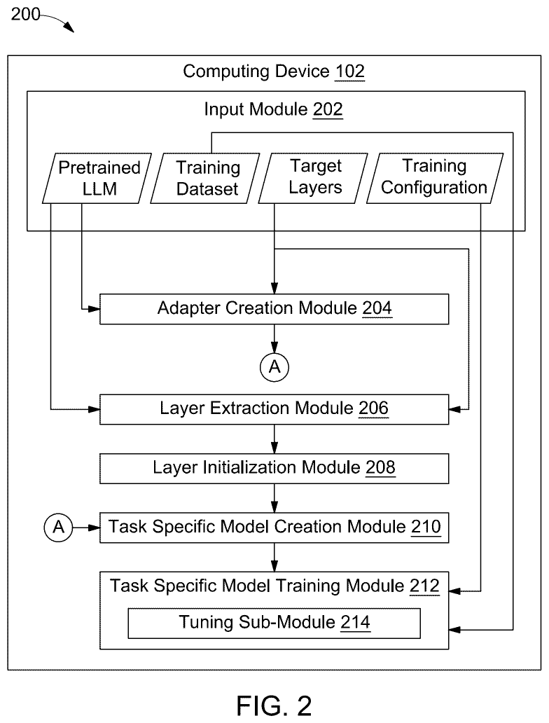

Referring now to FIG. 2, a schematic diagram 200 of the computing device 102 is illustrated, in accordance with an embodiment of the present disclosure. In an embodiment, the computing device 102 may include an input module 202, an adapter creation module 204, a layer extraction module 206, a layer initialization module 208, and a task-specific model creation module 210, and a task specific model training module 212.

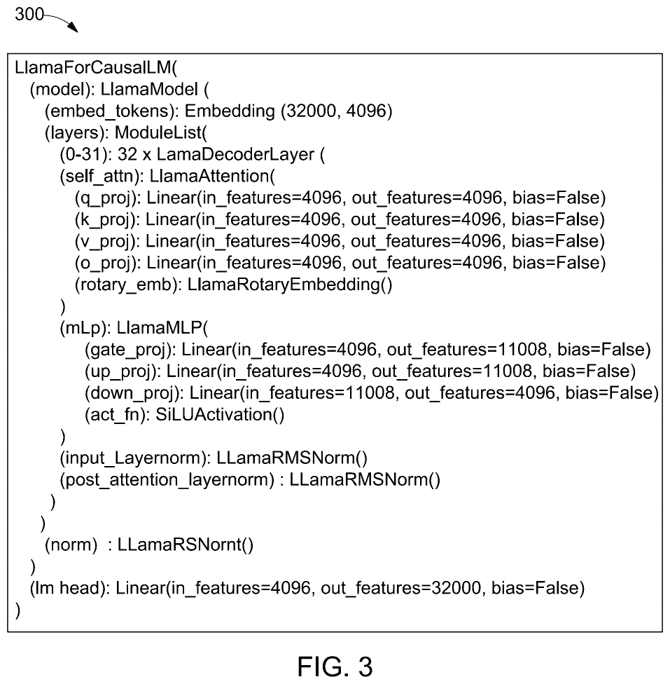

The input module 202 may receive a pretrained LLM, training dataset for each of a plurality of adapters, a set of target layers as an input. It should be noted that the input may be indicated or provided by a user via the I/O device 108. For example, the user may indicate the file path for the pretrained LLM and the training dataset and may provide the set of target layers. Additionally, in an embodiment, the input module 202 may also receive training configurations corresponding to each of the plurality of adapters from the user. In an embodiment, the pretrained LLM may be trained LLM for general-purpose. In an embodiment, each of the plurality of adapters may be associated with a corresponding task. In an embodiment, the task may include, but is not limited to, text summarization, question & answering, and text translation corresponding to a specific domain. Referring now to FIG. 3, an exemplary pretrained LLM 300 is illustrated, in accordance with an embodiment of the present disclosure. As will be appreciated, the pretrained LLM 300 may be adapted by the computing device 102 for specific tasks in accordance with the methodology of the present disclosure. In an embodiment, examples of the pretrained LLM may include, but are not limited to, zephyr, code LLAMA, GPT, etc. The pretrained LLM 300 typically has an attention module and a Multilayer Perceptron (MLP) module. The attention module may include query projection layers, key projection layers, value projection layers, and output projection layers. Similarly, MLP module may include gate projection layers, up projection layers, and down projection layers.

Referring back to FIG. 2, the plurality of adapters may be created by the adapter creation module 204 based on the set of target layers and the pretrained LLM using one of a plurality of adapter creation techniques. In an embodiment, the adapter creation techniques may include a Low-Rank Adaptation (LoRA), a Quantized Low-Rank Adaptation (QLoRA), and prefix tuning. It should be noted that each adapter may be created and subsequently trained to perform a specific task. In an exemplary embodiment, there may be three tasks T1 (e.g., text summarization), T2 (e.g., question & answering), and T3 (e.g., text translation). For these three tasks, three adapters (one for each task) may be created. Further, each of the created adapters may be integrated into the set of target layers of the pretrained LLM. In an embodiment, the target layers may be one or more of the key projection layers, the query projection layers, the value projection layers, and the output projection layers. Alternatively, in an embodiment, the target layers may be one or more of the key projection layers, the query projection layers, the value projection layers, the output projection layers, the gate projection layers, the up-projection layers, and the down projection layers.

As discussed above, the set of target layers may be one or more layers from a plurality layers of the pretrained LLM. The one or more layers are those layers where each of the plurality of adapters may be added. In an embodiment, the set or target layers may be a default selection of the one or more layers of the pretrained LLM. It should be noted that the default selection may be based on model complexity, resource constraints, and hardware capabilities. Alternatively, in an embodiment, the set of target layers may be specified by the user based on their understanding of model complexity and resource constraints, as well as based on their preference and domain experience. In other words, the user may specify the layer(s) to which the adapters may be added. For example, in an embodiment, the user may modify the default selection based on their understanding of model complexity and resource constraints, as well as based on their preference and domain experience.

Further, the layer extraction module 206 may extract a set of layers from the pretrained LLM based on the set of target layers. It should be noted that, in an embodiment, the extracted layers may be a replication of the target layers of the pretrained LLM. Further, the layer initialization module 208 may initialize the set of layers (i.e., the extracted layers) as a set of shared layers for each of the plurality of adapters. In other words, the extracted layers are shared among each of the plurality of adapters. Such sharing may increase resource unitization efficiency as well as decrease the replication of non-trainable parameters (i.e., parameters associated with the target layers of the pretrained LLM), the training time, and the overall memory usage during the training process.

Further, the task specific model creation module 210 may create a plurality of task specific models based on the plurality of adapters and the set of shared layers. In other words, each task specific model may include a corresponding adapter and the set of shared layers. In an embodiment, each of the task specific model may include adapter weights of the corresponding adapter. The each of the task specific model may utilize the set of shared layers and the corresponding adapter. The set of shared layers may serve as a bridge between the pretrained LLM and the corresponding adapter. As stated above, in order to train the plurality of task specific models, the input module 202 may receive training configuration for each of the plurality of task specific models. In an embodiment, the training configuration may include a learning rate, a batch size, and a number of training epochs.

Accordingly, the task specific model training module 212 may train each of the plurality of task specific models with a corresponding training dataset, concurrently. In an embodiment, training each of the plurality of task specific models may be based on a corresponding training configuration. In an embodiment, in order to train each of the plurality of task specific models, the task specific model training module 212 may input the corresponding training dataset to a corresponding task specific model. The task specific model training module 212 may further include a tuning sub-module 214 to tune adapter weights of the corresponding adapter, while keeping weights of the pretrained LLM frozen (i.e., unchanged). In an embodiment, in order to tune adapter weights, the tuning sub-module 214 may determine a loss for the corresponding task specific model and further update the adapter weights based on the loss, while keeping weights of the set of shared layers frozen.

It should be noted that all such aforementioned modules 202-214 may be represented as a single module or a combination of different modules. Further, as will be appreciated by those skilled in the art, each of the modules 202-214 may reside, in whole or in parts, on one device or multiple devices in communication with each other. In some embodiments, each of the modules 202-214 may be implemented as dedicated hardware circuit comprising custom application-specific integrated circuit (ASIC) or gate arrays, off-the-shelf semiconductors such as logic chips, transistors, or other discrete components. Each of the modules 202-214 may also be implemented in a programmable hardware device such as a field programmable gate array (FGPA), programmable array logic, programmable logic device, and so forth. Alternatively, each of the modules 202-214 may be implemented in software for execution by various types of processors (e.g. processor 104). An identified module of executable code may, for instance, include one or more physical or logical blocks of computer instructions, which may, for instance, be organized as an object, procedure, function, or other construct. Nevertheless, the executables of an identified module or component need not be physically located together but may include disparate instructions stored in different locations which, when joined logically together, include the module and achieve the stated purpose of the module. Indeed, a module of executable code could be a single instruction, or many instructions, and may even be distributed over several different code segments, among different applications, and across several memory devices.

As will be appreciated by one skilled in the art, a variety of processes may be employed for adapting LLM for specific tasks. For example, the exemplary system 100 and the associated computing device 102 may adapt LLM for specific tasks by the processes discussed herein. In particular, as will be appreciated by those of ordinary skill in the art, control logic and/or automated routines for performing the techniques and steps described herein may be implemented by the system 100 and the associated computing device 102 either by hardware, software, or combinations of hardware and software. For example, suitable code may be accessed and executed by the one or more processors on the system 100 to perform some or all of the techniques described herein. Similarly, application specific integrated circuits (ASICs) configured to perform some, or all of the processes described herein may be included in the one or more processors on the system 100.

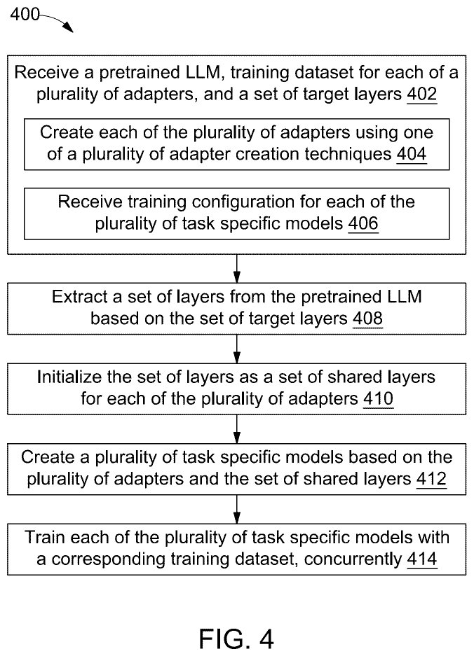

Referring to FIG. 4, a flow diagram of a methodology 400 of adapting LLM for specific tasks is illustrated, in accordance with an embodiment of present disclosure. FIG. 4 is explained in conjunction with FIGS. 1 and 2. In an embodiment, the methodology 400 may include a plurality of steps that may be performed by various modules of the computing device 102 so as to adapt LLM for specific tasks.

At step 402, the computing device 102 may receive a pretrained LLM, training dataset for each of a plurality of adapters, and a set of target layers. In an embodiment, the pretrained LLM may be a trained LLM for a specific domain. In an embodiment, examples of the pretrained LLM may include, but are not limited to, zephyr, code LLAMA, GPT, etc. In an embodiment, each of the plurality of adapters may be associated with a corresponding task. In an embodiment, the task may include, but is not limited to, text summarization, question & answering, and text translation.

In an embodiment, at sub-step 404, the computing device 102 may create the plurality of adapters. As discussed above, the computing device 102 may create the plurality of adapters based on the set of target layers and the pretrained LLM using one of a plurality of adapter creation techniques. In an embodiment, the adapter creation techniques may include a Low-Rank Adaptation (LoRA), a Quantized Low-Rank Adaptation (QLoRA), and prefix tuning.

Further, in an embodiment, at sub-step 406, the computing device 104 may receive

training configuration for each of the plurality of task specific models. In an embodiment, the training configuration may include a learning rate, a batch size, and a number of training epochs.

In an embodiment, the set of target layers may be one or more layers from a plurality of layers of the pretrained LLM where each of the plurality of adapters may be added. In an embodiment, the set or target layers may be a default selection of one or more of the plurality of layers of the pretrained LLM. It should be noted that the default selection may be based on model complexity, resource constraints, and hardware capabilities. Alternatively, in an embodiment, the set of target layers may be specified by the user based on model complexity, resource constraints, and hardware capabilities as well as based on their preference and domain experience. For example, in an embodiment, the user may modify the default selection based on their preference and domain experience.

Further, at step 408, the computing device 102 may extract a set of layers from the pretrained LLM based on the set of target layers. It should be noted that, in an embodiment, the target layers of the pretrained LLM may be replicated to form the set of extracted layers.

Further, at step 410, the computing device 102 may initialize the set of layers (i.e., the extracted layers) as a set of shared layers for each of the plurality of adapters. Thus, the extracted layers may be shared among each of the plurality of adapters while training the adapter so as to achieve computational and operational efficiency.

Further, at step 412, the computing device 102 may create a plurality of task specific models based on the plurality of adapters and the set of shared layers. It should be noted that each task specific model may include a corresponding adapter (for a specific task) and the set of shared layers.

Further, at step 414, the computing device 102 may train each of the plurality of task

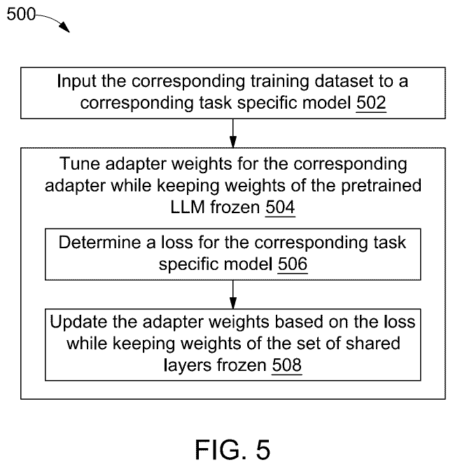

specific models with a corresponding training dataset, concurrently. In an embodiment, the training of each of the plurality of task specific models may be based on the corresponding training configuration. The training of each of the plurality of task specific models may be described in greater details in conjunction with FIG. 5 herein below.

Referring to FIG. 5, a flow diagram of a methodology 500 of training each of plurality of task specific models is illustrated, in accordance with an embodiment of present disclosure. FIG. 5 is explained in conjunction with FIGS. 1 and 2. In an embodiment, the methodology 500 may include a plurality of steps that may be performed by various modules of the computing device 102 so as to train each of the plurality of task specific models.

In order to train each of the plurality of task specific models, at step 502, the computing device 102 may input the corresponding training dataset to a corresponding task specific model.

Further at step 504, the computing device 102 may tune adapter weights of the

corresponding adapter, while keeping weights of the pretrained LLM frozen (i.e., unchanged). In order to tune adapter weights, at sub-step 506, the computing device 102 may determine a loss for the corresponding task specific model. Further, at sub-step 508, the computing device 102 may update the adapter weights based on the loss, while keeping weights of the set of shared layers frozen.

As will be appreciated by those skilled in the art, the techniques described in the various embodiments discussed above are not routine, or conventional, or well-understood in the art. The techniques discussed above provide for adapting LLM for specific tasks.

By avoiding redundant loads of non-trainable parameters (i.e., parameters associated with the target layers of the pretrained LLM), the disclosed method and system reduces the overall memory usage during the training process. This efficiency is achieved by sharing the layers (and associated parameters) of the pretrained LLM across multiple adapters as a set of shared layers among the multiple adapters, thereby eliminating the need to load these parameters (i.e., parameters associated with the target layers of the pretrained LLM) multiple times for multiple adapters.

The disclosed method and system reduce the overall training time by allowing simultaneous training of various adapters for different tasks. The concurrent training approach leverages the shared pretrained LLM to optimize the use of computational resources and speeding up the training process.

The disclosed method and system reduce the memory usage and the training time which translates to lower operational costs.

The disclosed method and system are versatile and can be applied across a wide range of tasks and domains. It should be noted that the techniques described herein are not limited to multi-adapter system but are applicable wherever there is a need for an LLM to specialize in various tasks or domains. This flexibility makes the disclosed method and system suitable for diverse applications in different fields which enhance its utility and relevance.

In light of the above-mentioned advantages and the technical advancements provided by the disclosed method and system, the claimed steps as discussed above are not routine, conventional, or well understood in the art, as the claimed steps enable the following solutions to the existing problems in conventional technologies. Further, the claimed steps bring an improvement in the functioning of the device itself as the claimed steps provide a technical solution to a technical problem.

The specification has described the method and system for adapting LLM for specific tasks. The illustrated steps are set out to explain the exemplary embodiments shown, and it should be anticipated that ongoing technological development will change the manner in which particular functions are performed. These examples are presented herein for the purpose of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

It is intended that the disclosure and examples be considered as exemplary only, with a true scope of disclosed embodiments being indicated by the following claims.

What is claimed is:

1. A method of adapting large language model (LLM) for specific tasks, the method comprising:
receiving, by a processor, a pretrained LLM, training dataset for each of a plurality of adapters, and a set of target layers, wherein each of the plurality of adapters is associated with a corresponding task, and wherein the set of target layers are one or more layers from a plurality of layers of the pretrained LLM where each of the plurality of adapters is to be added;
extracting, by the processor, a set of layers from the pretrained LLM based on the set of target layers;
initializing, by the processor, the set of layers as a set of shared layers for each of the plurality of adapters;
creating, by the processor, a plurality of task specific models based on the plurality of adapters and the set of shared layers, wherein each of the plurality of task specific models is associated with a corresponding adapter for the corresponding task; and
training, by the processor, each of the plurality of task specific models with a corresponding training dataset, concurrently.

2. The method of claim 1, wherein the set of target layers are based on model complexity, resource constraints, and hardware capabilities.

3. The method of claim 1, wherein training each of the plurality of task specific models comprises:
inputting, by the processor, the corresponding training dataset to a corresponding task specific model; and
tuning, by the processor, adapter weights of the corresponding adapter while keeping weights of the pretrained LLM frozen.

4. The method of claim 3, wherein tuning adapter weights comprises:
determining, by the processor, a loss for the corresponding task specific model; and
updating, by the processor, the adapter weights based on the loss while keeping weights of the set of shared layers frozen.

5. The method of claim 1, comprising:
receiving, by the processor, training configuration for each of the plurality of task specific models,
wherein the training configuration comprises a learning rate, a batch size, and a number of training epochs, and
wherein training each of the plurality of task specific models is based on a corresponding training configuration for the corresponding task specific model.

6. The method of claim 1, comprising:
creating, by the processor, each of the plurality of adapters using one of a plurality of adapter creation techniques, wherein the adapter creation techniques comprise a Low-Rank Adaptation (LoRA), a Quantized Low-Rank Adaptation (QLoRA), and prefix tuning.

7. A system for adapting large language model (LLM) for specific tasks, comprising:
a processor;
a memory communicably coupled to the processor, wherein the memory stores processor-executable instructions, which, on execution, cause the processor to:
receive a pretrained LLM, training dataset for each of a plurality of adapters, and a set of target layers, wherein each of the plurality of adaptors is associated with a corresponding task, and wherein the set of target layers are one or more layers from a plurality of layers of the pretrained LLM where each of the plurality of adapter is to be added;
extract a set of layers from the pretrained LLM based on the set of target layers;
initialize the set of layers as a set of shared layers for each of the plurality of adapters;
create a plurality of task specific models based on the plurality of adapters and the set of shared layers, wherein each of the plurality of task specific models is associated with a corresponding adapter for the corresponding task; and
train each of the plurality of task specific models, concurrently, with a corresponding training dataset.

8. The system of claim 7, wherein to train each of the plurality of task specific models, the processor-executable instructions, which, on execution, cause the processor to:
input the corresponding training dataset to a corresponding task specific model; and
tune adapter weights of the corresponding adapter while keeping weights of the pretrained LLM frozen.

9. The system of claim 8, wherein to tune adapter weights, the processor-executable instructions, which, on execution, cause the processor to:
determine a loss for the corresponding task specific model; and
update the adapter weights based on the loss while keeping weights of the set of shared layers frozen.

10. The system of claim 7, wherein the processor-executable instructions, which, on execution, cause the processor to:
receive training configuration for each of the plurality of task specific models,
wherein the training configuration comprises a learning rate, a batch size, and a number of training epochs, and
wherein training each of the plurality of task specific models is based on the corresponding training configuration for the corresponding task specific model.

11. A non-transitory computer-readable medium storing computer-executable instructions for adapting large language model (LLM) for specific tasks, the computer-executable instructions configured for:
receiving a pretrained LLM, training dataset for each of a plurality of adapters, and a set of target layers, wherein each of the plurality of adapters is associated with a corresponding task, and wherein the set of target layers are one or more layers from a plurality of layers of the pretrained LLM where each of the plurality of adapters is to be added;
extracting a set of layers from the pretrained LLM based on the set of target layers;
initializing the set of layers as a set of shared layers for each of the plurality of adapters;
creating a plurality of task specific models based on the plurality of adapters and the set of shared layers, wherein each of the plurality of task specific models is associated with a corresponding adapter for the corresponding task; and
training each of the plurality of task specific models with a corresponding training dataset, concurrently.

12. The non-transitory computer-readable medium of claim 11, wherein the set of target layers are based on model complexity, resource constraints, and hardware capabilities.

13. The non-transitory computer-readable medium of claim 11, wherein to train each of the plurality of task specific models, the computer-executable instructions are further configured for:
inputting the corresponding training dataset to a corresponding task specific model; and
tuning adapter weights of the corresponding adapter while keeping weights of the pretrained LLM frozen.

14. The non-transitory computer-readable medium of claim 13, wherein to tune adapter weights, the computer-executable instructions are further configured for:
determining a loss for the corresponding task specific model; and
updating the adapter weights based on the loss while keeping weights of the set of shared layers frozen.

15. The non-transitory computer-readable medium of claim 11, wherein the computer-executable instructions are further configured for:
receiving training configuration for each of the plurality of task specific models,
wherein the training configuration comprises a learning rate, a batch size, and a number of training epochs, and
wherein training each of the plurality of task specific models is based on a corresponding training configuration for the corresponding task specific model.

16. The non-transitory computer-readable medium of claim 11, wherein the computer-executable instructions are further configured for:
creating each of the plurality of adapters using one of a plurality of adapter creation techniques, wherein the adapter creation techniques comprise a Low-Rank Adaptation (LoRA), a Quantized Low-Rank Adaptation (QLoRA), and prefix tuning.
